(19) United States
(12) Patent Application Publication
(10) Pub. No.: US 2020/0198404 A1
(43) Pub. Date: Jun. 25, 2020

(54) PNEUMATIC TIRE

(71) Applicant: TOYO TIRE CORPORATION, Itami-shi (JP)

(72) Inventor: Naoya Kubo, Itami-shi (JP)

(73) Assignee: TOYO TIRE CORPORATION, Itami-shi (JP)

(21) Appl. No.: 16/711,912

(22) Filed: Dec. 12, 2019

(30) Foreign Application Priority Data
Dec. 21, 2018 (JP) 2018-240180

(51) Int. Cl. B60C 9/26; B60C 13/00; B60C 15/02; B60C 9/02

(52) U.S. Cl. CPC B60C 9/26; B60C 13/009; B60C 9/023; B60C 9/0207; B60C 15/02

(57) ABSTRACT

A pneumatic tire including a tread portion, a pair of sidewall portions, a pair of bead cores, a first ply, and a second ply being discontinuous and having a pair of ply pieces. The first ply includes a central portion positioned in the tread portion, a pair of side portions extending from opposite ends of the central portion, and a pair of folded-up portions folded up around the respective pair of bead cores. The pair of ply pieces each includes a side portion extending from an inner end, and a folded-up portion folded up around any one of the pair of bead cores. In each of the sidewall portions, the first ply has a plurality of first cords extending in the tire radial direction, and the pair of ply pieces each has a plurality of second cords extending at an angle from the first cords.

### CROSS-REFERENCE TO RELATED APPLICATIONS

This application claims priority of Japanese Patent Application No.: 2018-240180 filed on Dec. 21, 2018, the content of which is incorporated herein by reference.

### BACKGROUND OF THE INVENTION

### Technical Field

The present invention relates to a pneumatic tire.

### Related Art

Japanese Patent Application Laid-Open No. 2007-176304 discloses a pneumatic tire provided with a carcass ply including a first ply that is continuous between a pair of bead portions, and a second ply that is disposed overlying the outside of the first ply in the tire radial direction. Each of these plies includes a plurality of cords disposed parallel to each other at intervals. In a sidewall portion, the cords of the first ply are inclined in a first tire circumferential direction from the inside toward the outside in the tire radial direction. In the sidewall portion, the cords of the second ply are inclined in a second tire circumferential direction from the inside toward the outside in the tire radial direction, intersecting the cords of the first ply.

### SUMMARY

The structure disclosed in Japanese Patent Laid-Open No. 2007-176304 has room for further improvement in terms of weight reduction and reduction in rolling resistance due to the weight reduction while securing rigidity and cut resistance.

It is an object of the present invention to achieve weight reduction and reduction in rolling resistance due to the weight reduction while rigidity and cut resistance are secured.

An aspect of the present invention provides a pneumatic tire including: a tread portion; a pair of sidewall portions extending inward in a tire radial direction from opposite ends of the tread portion; a pair of bead cores disposed in respective inner end portions of the pair of sidewall portions in the tire radial direction; a first ply having a central portion positioned inward of the tread portion in the tire radial direction, a pair of side portions extending inward from opposite ends of the central portion in the tire radial direction, and a pair of folded-up portions extending from the corresponding pair of side portions, being folded up around the corresponding pair of bead cores; and a second ply being discontinuous disposed outward of the first ply in the tire radial direction, including a pair of ply pieces each having an inner end positioned in the tread portion, a side portion extending inward from the inner end in the tire radial direction, and a folded-up portion provided continuously with the side portion, being folded up around any one of the pair of bead cores, the first ply having a plurality of first cords extending in the tire radial direction, being disposed parallel to each other at intervals in a tire circumference direction, in each of the sidewall portions, and the pair of ply pieces each having a plurality of second cords extending at an angle from the first cords, being disposed parallel to each other at intervals in the tire circumference direction, in each of the sidewall portions.

The second ply includes the pair of ply pieces and is discontinuous. That is, there is a cut-out portion with no ply existing between the inner ends of the respective pair of ply pieces. The cut-out portion of the second ply is intended to achieve two types of basically conflicting performance. One type of performance is rigidity, which contributes to improvement in steering stability, and cut resistance, and the other type of performance is weight reduction and reduction in rolling resistance due to the weight reduction. Employing the second ply with the cut-out portion as described above enable the weight reduction as compared with the second ply formed of one continuous ply. This enables not only reduction in rolling resistance but also low fuel consumption of a vehicle.

Throughout each of the sidewall portions, two layers of plies, i.e., the side portion of the first ply and the side portion of the ply piece (second ply), are disposed. In a region near the bead core in each of the sidewall portions, further two layers of plies, i.e., the folded-up portion of the first ply and the folded-up portion of the ply piece (second ply), are disposed. As described above, providing the two or four layers of plies in each of the sidewall portions secures required cut resistance. Providing the two or four layers of plies also secures required rigidity in each of the sidewall portions.

In each of the sidewall portions, the first cords of the first ply including the folded-up portion, extending in the tire radial direction, enable each of the sidewall portions to be effectively improved in longitudinal rigidity in the tire radial direction. In each of the sidewall portions, the second cords of the second ply is inclined from the first cords (tire radial direction), and the second cords of the side portion and the second cords of the folded-up portion are inclined in respective directions opposite to each other. Thus, these cords extend in three directions and intersect each other when each of the sidewall portions is viewed from the tire width direction, so that a region with no cord extending is reduced. As a result, cut resistance and lateral rigidity in each of the sidewall portions can be effectively improved.

As described above, according to the present invention, weight reduction and reduction in rolling resistance due to the weight reduction can be achieved while rigidity, steering stability due to the rigidity, and cut resistance are secured.

The second cords of one of the pair of ply pieces and the second cords of the other of the pair of ply pieces are inclined in the same direction in the tire circumference direction from the inside toward the outside in the tire radial direction. According to this aspect, drifting of a vehicle (steering wheel) due to influence of an inclination direction of the cords can be prevented.

The second cords have an inclination angle of 20 degrees or more and 60 degrees or less from the first cords. According to this aspect, hoop effect (binding force) by the first cords and the second cords can be improved, so that each of the sidewall portions can be effectively improved in rigidity.

More specifically, the inclination angle is 20 degrees or more and 45 degrees or less. According to this aspect, the inclination direction of the second cords of the second ply is close to the tire radial direction, so that each of the sidewall portions can be improved in longitudinal rigidity.

One of the pair of sidewall portions faces outward disposed outside in the vehicle width direction, and the other of the pair of sidewall portions faces inward disposed inside in the vehicle width direction, and the inclination angle of the second cords constituting the sidewall portion facing outward is smaller than the inclination angle of the second cords constituting the sidewall portion facing inward. According to this aspect, the sidewall portion disposed outside can be improved in longitudinal rigidity, so that steering stability can be effectively improved.

The folded-up portion of the first ply has a first outer end positioned outward of a second outer end of the folded-up portion of each of the ply pieces in the tire radial direction, and an interval between the first outer end and the second outer end in the tire radial direction is 10 mm or more and 30 mm or less. In addition, there is provided a bead filler disposed outward of each of the bead cores in the tire radial direction, and the first outer end and the second outer end are disposed outward of the bead filler in the tire radial direction. According to these aspects, a step caused by the first and second plies can be minimized compared with the first ply and the second ply having outer ends aligned. Cut resistance also can be secured while increase in weight due to excessive increase in size of the folded-up portion of the first ply and the folded-up portion of the second ply is suppressed.

There is further provided a belt layer being disposed in the tread portion outward of the central portion of the first ply in the tire radial direction, and the inner end of each of the ply pieces is interposed between the belt layer and the central portion of the first ply. According to this aspect, the inner end of the ply piece is firmly held by the belt layer, so that rigidity of the second ply can be secured more reliably.

The pneumatic tire of the present invention can provide weight reduction and reduction in rolling resistance due to the weight reduction while securing rigidity and cut resistance.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to a first embodiment of the present invention;

FIG. 2 is a meridian cross-sectional view of a tread portion and its surroundings of the pneumatic tire according to the first embodiment of the present invention;

FIG. 3 is a partially enlarged view of FIG. 1;

FIG. 4 is a schematic view illustrating cord placement of a ply in a sidewall portion;

FIG. 5 is a development view of a first ply and a second ply of FIG. 4;

FIG. 6 is a schematic view illustrating cord placement of a ply of a pneumatic tire according to a second embodiment; and

FIG. 7 is a development view of a first ply and a second ply of the pneumatic tire according to the second embodiment.

### DETAILED DESCRIPTION OF EMBODIMENTS

Hereinafter, an embodiment of the present invention will be described with reference to drawings.

### First Embodiment

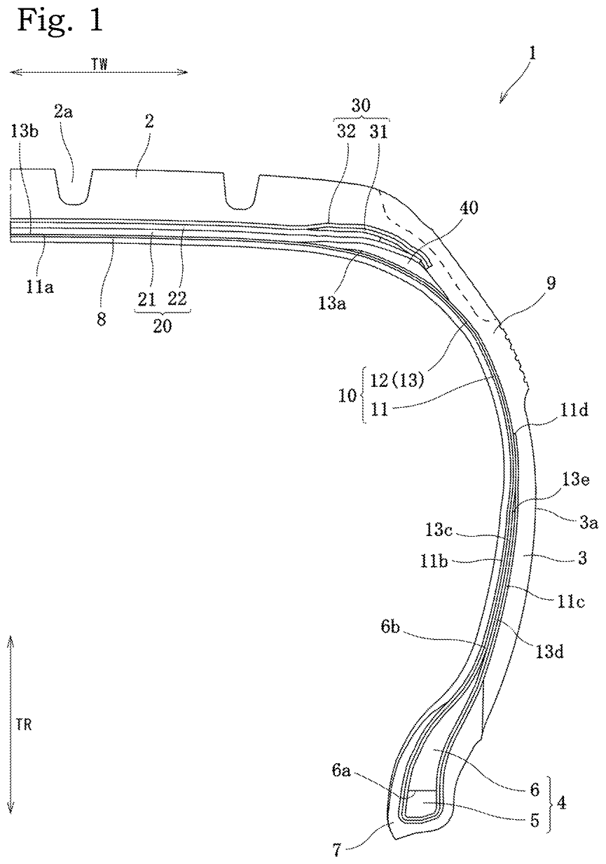

FIGS. 1 to 3 each illustrate a pneumatic tire (hereinafter referred to as a “tire”) 1 made of rubber according to an embodiment of the present invention.

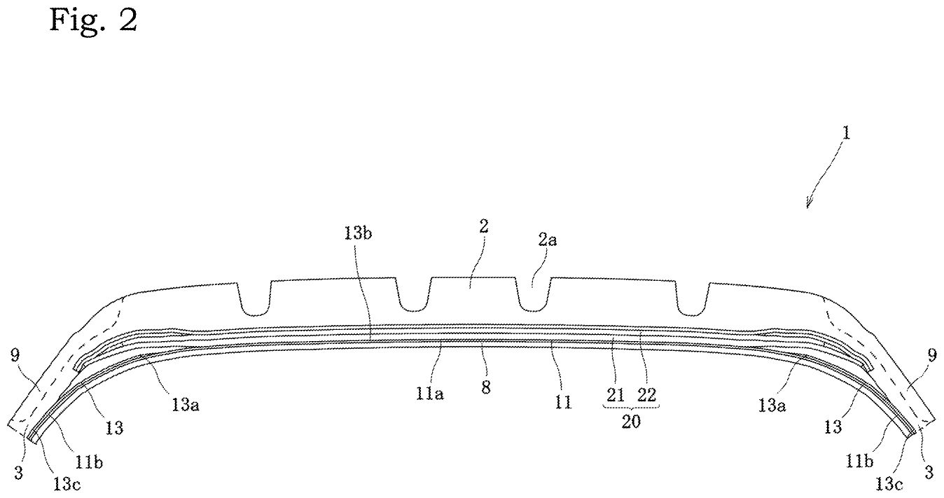

As illustrated in FIGS. 1 and 2, the tire 1 includes a tread portion 2, a pair of sidewall portions 3, and a pair of bead portions 4 in a ring shape.

The tread portion 2 extends in the tire width direction (indicated by the symbol TW in FIG. 1). A groove 2a is provided on the tread portion 2 surface, i.e., a tread surface.

The pair of sidewall portions 3 extends inward from opposite ends of the tread portion 2 in the tire radial direction (indicated by the symbol TR in FIG. 1).

The pair of bead portions 4 is disposed in radially inner end portions of the respective pair of sidewall portions 3. Each of the bead portions 4 includes a bead core 5 and a bead filler 6. The bead core 5 includes a great number of steel wires bundled in a ring shape. The bead filler 6 is formed in a ring shape and is made of rubber harder than rubber constituting the tread portion 2 and the sidewall portion 3. The bead filler 6 includes a base end 6a disposed adjacent to a radially outer side of the bead core 5, and a leading end 6b opposite to the base end 6a, and extends radially outward from the base end 6a toward the leading end 6b in a tapered shape. Each of the bead portions 4 includes a strip rubber 7 provided wrapping the bead core 5 and the bead filler 6.

The tire 1 includes a carcass 10 stretched between the bead portions 4 in a toroidal shape. The carcass 10 of the present embodiment includes a first carcass ply (hereinafter referred to as a “first ply”) 11 and a second carcass ply (hereinafter referred to as a “second ply”) 12. While the second ply 12 has a cut-out portion 13b, the first ply 11 is a normal ply without a cut-out portion. Both the first and second plies 11 and 12 will be described in detail below. An inner liner 8 is provided inside the carcass 10, i.e., on the innermost peripheral surface of the tire 1.

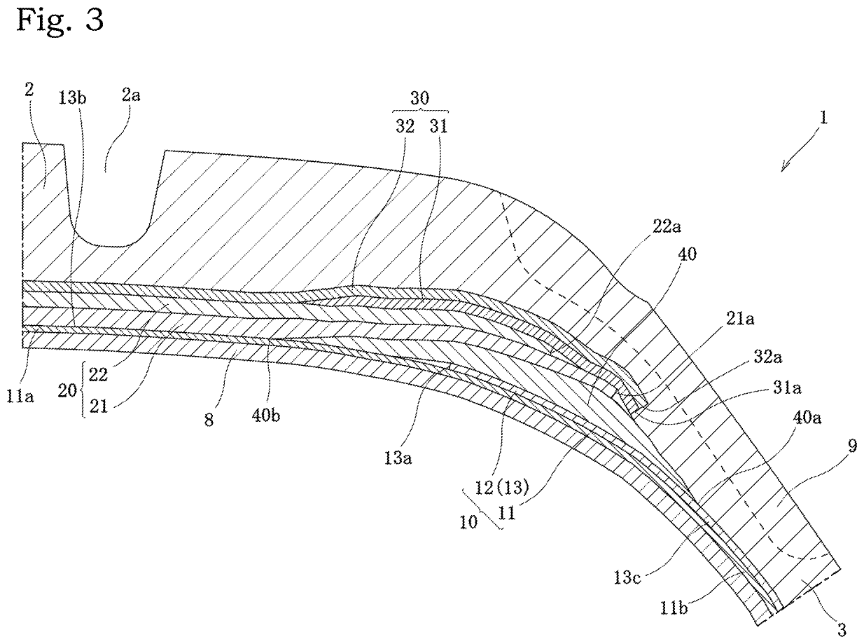

Referring to FIGS. 2 and 3, a belt layer 20 being endless is provided in the tread portion 2, more specifically, between the carcass 10 and the tread portion 2. In the present embodiment, the belt layer 20 includes two belts 21 and 22. The belt 21 is disposed adjacent to a radially outer side of the carcass 10, and the belt 22 is disposed adjacent to a radially outer side of the belt 21. In the present embodiment, the belt 21 in a lower layer has a dimension in the tire width direction more than a dimension of the belt 22 in an upper layer in the tire width direction, and the belt 21 has ends 21a positioned outward of respective ends 22a of the belt 22 in the tire width direction. The tread portion 2 is formed inward from each of the ends 21a of the belt 21 being widest in the tire width direction. The belts 21 and 22 are each formed by covering belt cords made of steel or organic fiber with rubber. The belt layer 20 may be composed of one belt or may be composed of three or more belts.

A cap layer 30 being endless is provided adjacent to a radially outer side of the belt layer 20. The cap layer 30 of the present embodiment includes a pair of edge plies 31 being narrow that is configured to directly cover any one of sets of the ends 21a and 22a of the corresponding belts 21 and 22. The cap layer 30 of the present embodiment also includes a cap ply 32 being wide that is disposed adjacent to a radially outer side of the edge plies 31 and that is configured to cover the entire belts 21 and 22 including the ends 21a and 22a with one sheet. The cap layer 30 may include one ply, or three or more plies. The cap layer 30 may be eliminated.

A pair of pads 40 made of rubber, being endless, is interposed between respective outer end portions of the belt layer 20 in the tire width direction and the carcass layer 10. The pad 40 has a cross-sectional shape of a flat triangular shape. The ends 21a and 22a of the corresponding belts 21 and 22, an end 31a of the edge ply 31 outward in the tire width direction, and an end 32a of the cap ply 32 in the tire width direction, are set to be positioned in a region between an end 40a of the pad 40 outward in the tire width direction and an end 40b of the pad 40 inward in the tire width direction, i.e., in a region with the pad 40 existing. The pad 40 may be eliminated.

Hereinafter, the first ply 11 and the second ply 12 constituting the carcass 10 will be described.

As described above, while the first ply 11 is a single ply, the second ply 12 is a discontinuous ply that has the cut-out portion 13b and that is composed of a pair of ply pieces 13. The first ply 11 and the ply pieces 13 of the second ply 12 are belt-like sheets with a plurality of cords 11e and 13f (refer to FIG. 5), respectively, being disposed parallel to each other at intervals and covered with rubber.

The first ply 11 includes a central portion 11a, a pair of side portions 11b, and a pair of folded-up portions 11c. The central portion 11a is disposed radially inward of the tread portion 2. The pair of side portions 11b is disposed in the respective sidewall portion 3 while extending radially inward from respective ends of the central portion 11a in the tire width direction. The pair of folded-up portions 11c is continuous with respective radially inner ends of the pair of side portions 11b. Each of the folded-up portions 11c is folded up from the inside to the outside in the tire width direction around the corresponding one of the pair of bead cores 5 and terminates at the sidewall portion 3.

The second ply 12 is disposed adjacent to the first ply 11 on its radially outer side, and is a discontinuous ply composed of the pair of ply pieces 13. The ply piece 13 has an inner end 13a disposed between the belt layer 20 and the central portion 11a of the first ply 11. The pad 40 is interposed between the inner end 13a and the belt layer 20. The ply piece 13 is set to have the inner end 13a at a position in the tire width direction in an outer region of the tread portion 2 in the tire width direction, more specifically, in a region inward of both the ends 21a and 22a of the corresponding belts 21 and 22 constituting the belt layer 20, in the tire width direction. The cut-out portion 13b is provided in a central region in the tread portion 2 in the tire width direction, more specifically, in a region between inner ends 13a of the respective pair of ply pieces 13. In the cut-out portion 13b, the second ply 12 does not exist, and only the central portion 11a of the first ply 11 exists.

The ply piece 13 includes a side portion 13c extending radially inward from the inner end 13a, and a folded-up portion 13d provided continuously with the side portion 13c. The side portion 13c is disposed overlying the outside of the side portion 11b of the first ply 11 in the tire width direction. The folded-up portion 13d is folded up from the inside to the outside in the tire width direction around the bead core 5, and terminates at the sidewall portion 3. The folded-up portion 13d is disposed overlying the inside of the folded-up portion 11c of the first ply 11 in the tire width direction, and is disposed overlying the outside of the side portion 13c in the tire width direction, radially outward of the bead filler 6.

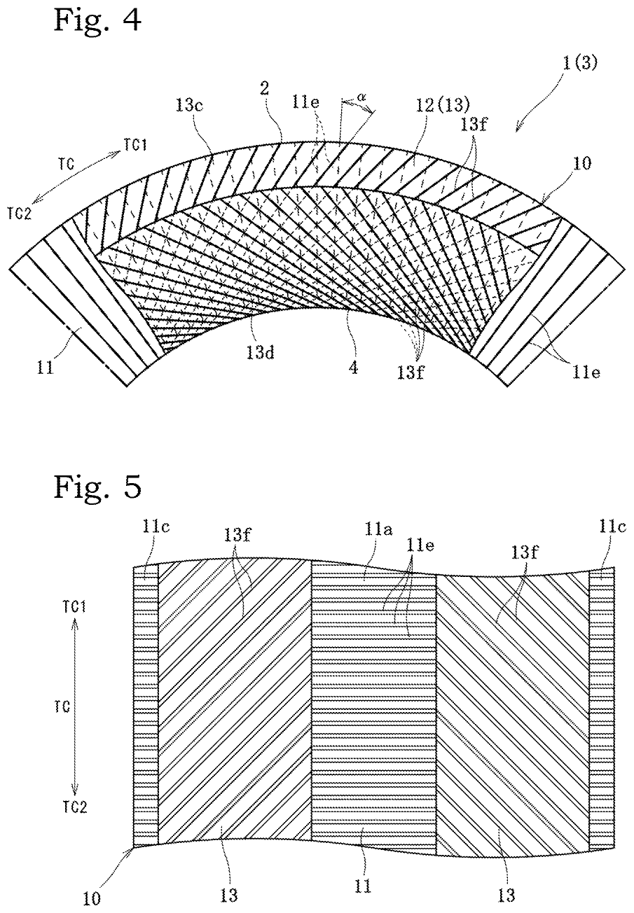

Referring to FIGS. 4 and 5, the cords (first cords) 11e of the first ply 11 and the cords (second cords) 13f of the pair of ply pieces 13 are different in extending direction. FIG. 4 illustrates cord placement of one of the pair of sidewall portions 3 (on the right side in FIG. 5) as viewed from the tire width direction, and the other of the pair of sidewall portions 3 (on the left side in FIG. 5) appears symmetrically to FIG. 4. FIG. 5 illustrates a developed state of the first ply 11 and the second ply 12 (the pair of ply pieces 13).

Specifically, as illustrated in FIG. 4, the cords 11e of the first ply 11 extend in the tire radial direction in the sidewall portion 3, and are disposed parallel to each other at intervals in the tire circumferential direction (indicated by the symbol TC in FIG. 1). The cords 13f of the pair of ply pieces 13 extend at an angle from the cords 11e of the first ply 11 in the sidewall portion 3, and are disposed parallel to each other at intervals in the tire circumferential direction while being inclined.

Referring also to FIG. 5, the cords 13f of one of the pair of ply pieces 13 and the cords 13f of the other thereof are inclined in the same direction TC1 in the tire circumferential direction from the inside toward the outside in the tire radial direction. In the ply piece 13, the cords 13f of the side portion 13c are inclined in a first circumferential direction from the cords 11e of the first ply 11, and the cords 13f of the folded-up portion 13d are inclined in a direction (second direction) opposite to that in the side portion 13c from the cords 11e of the first ply 11. Thus, when the sidewall portion 3 is viewed from the tire width direction, the cords 11e of the first ply 11 and the cords 13f of the ply piece 13 of the second ply 12 extend in three different directions and intersect each other.

An inclination angle α of the cord 13f of the ply piece 13 from the cord 11e of the first ply 11, i.e., an angle formed by the cord 11e and the cord 13f, is identical in one of the pair of ply pieces 13 and the other thereof. This inclination angle α is set to 20 degrees or more and 60 degrees or less, more preferably to 20 degrees or more and 45 degrees or less, and is set to 45 degrees in the present embodiment. When the inclination angle α is excessively reduced, i.e., when the cord 13f is inclined close to the tire radial direction, a region without the cords 11e and 13f extending increases. This reduces contribution to improvement in cut resistance and lateral rigidity. In addition, hoop effect (binding force) deteriorates, so that contribution to improvement in rigidity of the sidewall portion 3 is reduced. On the other hand, when the inclination angle α is excessively increased, the extending direction of the cord 13f is close to the tire circumferential direction TC. This reduces contribution to improvement in longitudinal rigidity of the sidewall portion 3. To prevent these disadvantages, the inclination angle α of the cord 13f of the ply piece 13 from the cord 11e of the first ply 11 is preferably set in the above range.

In the present embodiment, placement of an outer end 11d of the first ply 11 and an outer end 13e of the ply piece 13, and placement of the inner end 13a of the ply piece 13, are optimized.

Specifically, as illustrated in FIG. 1, the outer end 11d of the first ply 11 is positioned radially outward of the leading end 6b of the bead filler 6, and is positioned radially inward of the tread portion 2. More specifically, the outer end 11d is disposed radially outward of a maximum width position 3a of the sidewall portion 3, and is disposed near a radially inner end of a buttress portion 9. The buttress portion 9 is formed radially outward of the sidewall portion 3 while protruding outward in the tire width direction with a rubber thickness thicker than other portions.

The outer end 13e of the ply piece 13 is positioned between the leading end 6b of the bead filler 6 and the outer end 11d of the first ply 11. More specifically, the outer end 13e is disposed near the maximum width position 3a of the sidewall portion 3 while having a radial interval of 10 mm or more and 30 mm or less from the outer end 11d of the first ply 11. When the interval between the outer end 13e of the ply piece 13 and the outer end 11d of the first ply 11 is excessively reduced, the outer ends 11d and 13e come close to each other. Then, a step formed by the outer ends may cause a large gap between rubber of the sidewall portion 3 and the outer ends (process defect). On the other hand, when the interval is excessively increased, contribution to improvement in rigidity of the sidewall portion 3 with the folded-up portion 13d of the second ply 12 is reduced. To secure rigidity and cut resistance in the sidewall portion 3 while preventing the disadvantages above, the interval between the outer ends 11d and 13e is preferably set in the above range.

Referring to FIG. 3, the inner end 13a of the ply piece 13 is positioned inward of the end 21a of the belt 21 in the tire width direction, and an inner end 13a side of the ply piece 13 overlaps the belt 21 in the tire width direction. The ply piece 13 is preferably set to have an overlapping ratio more than 0% (i.e., 0 is not included) and 30% or less of a width of the belt 21 in the tire width direction. When the overlapping ratio is 0% or less (i.e., when there is no overlap), the inner end 13a of the ply piece 13 cannot be positioned by the belt 21 with the pad 40 interposed therebetween. Thus, rigidity of the sidewall portion 3 cannot be secured by the ply piece 13. When the overlapping ratio is more than 30%, contribution to weight reduction and reduction in rolling resistance with the tread portion 12 is reduced. To prevent these disadvantages, the overlapping ratio of the ply piece 13 and the belt 21 is preferably set within the above range.

Next, features of the pneumatic tire 1 of the present embodiment will be described.

The second ply 12 is a discontinuous ply provided with the pair of ply pieces 13, and there is the cut-out portion 13b with no ply existing between the inner ends 13b of the respective pair of ply pieces 13. Employing the second ply 12 with the cut-out portion 13b as described above enables the weight reduction as compared with the second ply 12 formed of one continuous ply. This enables not only reduction in rolling resistance but also low fuel consumption of a vehicle.

Throughout the sidewall portion 3, two layers of plies, i.e., the side portion 11b of the first ply 11 and the side portion 13c of the ply piece 12, are disposed. In a region near the bead core 5 in the sidewall portion 3, further two layers of plies, i.e., the folded-up portion 11c of the first ply 11 and the folded-up portion 13d of the ply piece 13, are disposed. As described above, providing the two or four layers of plies in the sidewall portion 3 secures required cut resistance. Providing the two or four layers of plies also secures required rigidity in the sidewall portion 3.

In the sidewall portion 3, cords Ile of the first ply 11 including the folded-up portion 11c, extending in the tire radial direction, enable the sidewall portion 3 to be effectively improved in longitudinal rigidity in the tire radial direction. In the sidewall portion 3, the cords 13f of the ply piece 13 are inclined from the cords 11e of the first ply 11, and the cords 13f of the side portion 13c and the cords 13f of the folded-up portion 13d are inclined in respective directions opposite to each other. Thus, these cords extend in three directions and intersect each other when the sidewall portion 3 is viewed from the tire width direction, so that a region without the cords 11e and 13f extending is reduced. As a result, cut resistance and lateral rigidity in the sidewall portion 3 can be effectively improved.

As discussed above, according to the present embodiment, weight reduction and reduction in rolling resistance due to the weight reduction can be achieved while rigidity, steering stability due to the rigidity, and cut resistance are secured.

As described above, the cords 13f of the pair of ply pieces 13 are inclined in the same direction in the tire circumferential direction from the inner side to the outer side in the tire radial direction. This structure enables preventing drifting of a vehicle (steering wheel) due to influence of an inclination direction of the cords.

As described above, the cord 11e has an inclination angle α of 20 degrees or more and 60 degrees or less from the cord 13f. This structure enables hoop effect (binding force) by the cord 11e and the cord 13f to be improved, so that the sidewall portion 3 can be effectively improved in rigidity. More specifically, the inclination angle α is 20 degrees or more and 45 degrees or less. This structure allows the inclination direction of the cord 13f of the ply piece 13 to be close to the tire radial direction, so that the sidewall portion 3 can be effectively improved in longitudinal rigidity.

As described above, the outer end 11d of the first ply 11 and the outer end 13e of the ply piece 13 are disposed at a predetermined interval. This structure enables a step caused by the first ply and the ply piece to be minimized compared with when positions of the outer ends 11d and 13e are aligned. In addition, the outer end 13e of the ply piece 13 can be covered with the folded-up portion 11c of the first ply 11, so that the number of steps generated between the rubber of the sidewall portion 3 and the outer ends can be minimized.

As described above, the outer end 11d of the first ply 11 and the outer end 13e of the ply piece 13 are positioned radially outward of the leading end 6b of the bead filler 6, and is positioned radially inward of the tread portion 2. This structure allows the sidewall portion 3 to sufficiently secure a region where four layers of plies, i.e., the side portion 11b of the first ply 11, the side portion 13c of the ply piece 13, the folded-up portion 13d of the ply piece 13, and the folded-up portion 11c of the first ply 11, exist. As a result, rigidity and cut resistance can be secured more reliably.

As described above, the inner end 13a of the ply piece 13 is interposed between the belt layer 20 and the central portion 11a of the first ply 11. This structure allows the inner end 13a of the ply piece 13 to be firmly held by the belt layer 20, so that rigidity of the second ply 12 can be secured more reliably.

### Second Embodiment

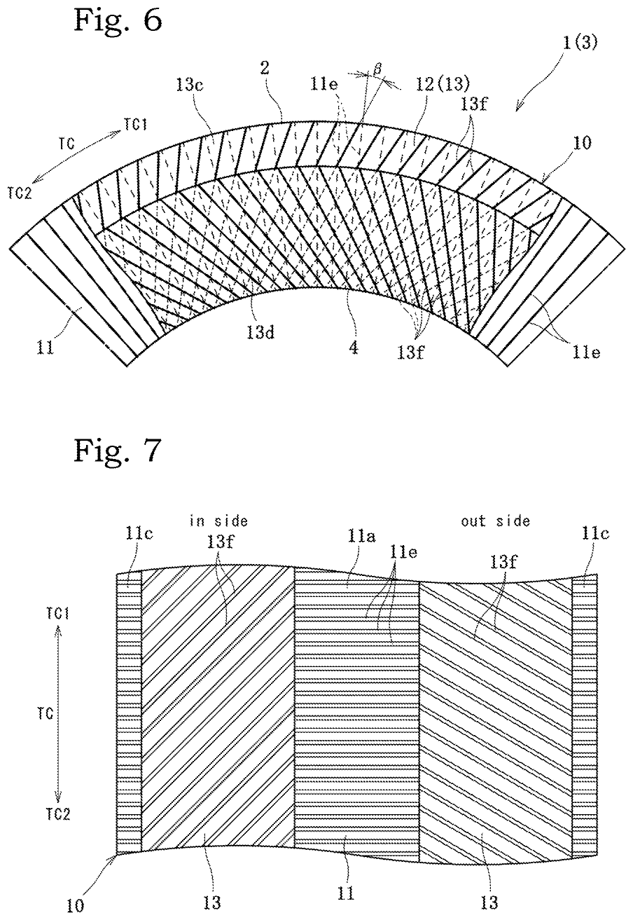

FIGS. 6 and 7 each illustrate a pneumatic tire 10 of a second embodiment. The second embodiment differs from the first embodiment in that a cord 13f of one of a pair of ply pieces 13 constituting a second ply 12, and a cord 13f of the other thereof, respectively have inclination angles α and β that are different from each other, and the second embodiment is identical to the first embodiment in other points. FIG. 6 illustrates cord placement when a sidewall portion 3 on an outer side is viewed from the tire width direction, and cord placement when a sidewall portion 3 on an inner side is viewed from the tire width direction appears symmetrically to FIG. 6.

The ply piece 13 positioned left in FIG. 7 faces inward disposed inside in the vehicle width direction, and the ply piece 13 positioned left in FIG. 7 faces outward disposed outside in the vehicle width direction. As with the first embodiment, the cords 13f of the ply pieces 13 are inclined in the same direction in the tire circumferential direction.

Each of the inclination angles α and β of the corresponding one of the cord 13f of one of the pair of ply pieces 13 and the cord 13f of the other thereof is set to a predetermined range similar to that in the first embodiment. The inclination angle β of the cord 13f on the outer side is smaller than the inclination angle α of the cord 13f on the inner side ((<α), and is close to an angle of the cord 11e of the first ply 11 (tire radial direction). For example, the inclination angle α of the cord 13f of the ply piece 13 facing inward is set to 45 degrees as in the first embodiment, and the inclination angle β of the cord 13f of the ply piece 13 facing outward is set to 30 degrees.

The tire 10 of the second embodiment can acquire operations and effects similar to those of the first embodiment. In addition, the inclination angle β of the cord 13f of the ply piece 13 on the outer side is smaller than the inclination angle α of the cord 13f of the ply piece 13 on the inner side, so that the sidewall portion 3 on the outer side can be further improved in longitudinal rigidity, and thus steering stability can be improved effectively.

The pneumatic tire 10 of the present invention is not limited to the structure of the above embodiments, and various modifications are available.

For example, the pneumatic tire 10 may have a three-ply structure including two first plies 11 and a second ply 12 having a pair of ply pieces 13, and the number of layered plies can be changed as necessary. The first ply 11 and the pair of ply pieces 13 of the second ply 12 may be different in cord material.

What is claimed is:

1. A pneumatic tire comprising:
a tread portion;
a pair of sidewall portions extending inward in a tire radial direction from opposite ends of the tread portion;
a pair of bead cores disposed in respective inner end portions of the pair of sidewall portions in the tire radial direction;
a first ply including a central portion positioned inward of the tread portion in the tire radial direction, a pair of side portions extending inward from opposite ends of the central portion in the tire radial direction, and a pair of folded-up portions extending from the corresponding pair of side portions and being folded up around the corresponding pair of bead cores; and
a second ply being discontinuous disposed outward of the first ply in the tire radial direction, including a pair of ply pieces each having an inner end positioned in the tread portion, a side portion extending inward from the inner end in the tire radial direction, and a folded-up portion provided continuously with the side portion and being folded up around8 any one of the pair of bead cores,
the first ply having a plurality of first cords extending in the tire radial direction, being disposed parallel to each other at intervals in a tire circumference direction, in each of the sidewall portions, and
the pair of ply pieces each having a plurality of second cords extending at an angle from the first cords, being disposed parallel to each other at intervals in the tire circumference direction, in each of the sidewall portions.

2. The pneumatic tire according to claim 1, wherein
the second cords of one of the pair of ply pieces and the second cords of the other of the pair of ply pieces are inclined in the same direction in the tire circumference direction from the inside toward the outside in the tire radial direction.

3. The pneumatic tire according to claim 1, wherein
the second cords has an inclination angle of 20 degrees or more and 60 degrees or less from the first cords.

4. The pneumatic tire according to claim 3, wherein
the inclination angle is 20 degrees or more and 45 degrees or less.

5. The pneumatic tire according to claim 3, wherein
one of the pair of sidewall portions faces outward disposed outside in the vehicle width direction,
the other of the pair of sidewall portions faces inward disposed inside in the vehicle width direction, and
the inclination angle of the second cords constituting the sidewall portion facing outward is smaller than the inclination angle of the second cords constituting the sidewall portion facing inward.

6. The pneumatic tire according to claim 1, wherein
the folded-up portion of the first ply has a first outer end positioned outward of a second outer end of the folded-up portion of each of the ply pieces in the tire radial direction, and an interval between the first outer end and the second outer end in the tire radial direction is 10 mm or more and 30 mm or less.

7. The pneumatic tire according to claim 6, further comprising:
a bead filler disposed outward of each of the bead cores in the tire radial direction,
wherein the first outer end and the second outer end are disposed outward of the bead filler in the tire radial direction.

8. The pneumatic tire according to claim 1, further comprising:
a belt layer being disposed in the tread portion outward of the central portion of the first ply in the tire radial direction,
wherein the inner end of each of the ply pieces is interposed between the belt layer and the central portion of the first ply.

9. The pneumatic tire according to claim 2, wherein
the folded-up portion of the first ply has a first outer end positioned outward of a second outer end of the folded-up portion of each of the ply pieces in the tire radial direction, and an interval between the first outer end and the second outer end in the tire radial direction is 10 mm or more and 30 mm or less.

10. The pneumatic tire according to claim 9, further comprising:
a bead filler disposed outward of each of the bead cores in the tire radial direction,
wherein the first outer end and the second outer end are disposed outward of the bead filler in the tire radial direction.

11. The pneumatic tire according to claim 2, further comprising:
a belt layer being disposed in the tread portion outward of the central portion of the first ply in the tire radial direction,
wherein the inner end of each of the ply pieces is interposed between the belt layer and the central portion of the first ply.

12. The pneumatic tire according to claim 5, further comprising:
a belt layer being disposed in the tread portion outward of the central portion of the first ply in the tire radial direction,
wherein the inner end of each of the ply pieces is interposed between the belt layer and the central portion of the first ply.

13. The pneumatic tire according to claim 6, further comprising:
a belt layer being disposed in the tread portion outward of the central portion of the first ply in the tire radial direction,
wherein the inner end of each of the ply pieces is interposed between the belt layer and the central portion of the first ply.

14. The pneumatic tire according to claim 7, further comprising:
a belt layer being disposed in the tread portion outward of the central portion of the first ply in the tire radial direction,
wherein the inner end of each of the ply pieces is interposed between the belt layer and the central portion of the first ply.
